(19) United States
(12) Patent Application Publication
(10) Pub. No.: US 2019/0037613 A1
(43) Pub. Date: Jan. 31, 2019

(54) PUBLIC WIRELESS INTERNET SERVICE (WISP) WITH AUTHENTICATION SUPPORTED BY MOBILE NETWORK OPERATOR (MNO)

(71) Applicant: QUALCOMM Incorporated, San Diego, CA (US)

(72) Inventors: Subramanian Anantharaman, Chennai (IN); Sreekanth Natarajan, Chennai (IN); Ponmudi Ramachandran, Chennai (IN)

(21) Appl. No.: 15/665,204

(22) Filed: Jul. 31, 2017

(51) Int. Cl. H04W 76/02; H04W 12/06; H04W 12/08

(52) U.S. Cl. CPC H04W 76/02; H04W 88/08; H04W 12/08; H04W 12/06

(57) ABSTRACT

This disclosure provides systems, methods, and apparatus, including computer programs encoded on computer-readable media, for an access point (AP) of a public wireless internet service provider (WISP) to authenticate a mobile device. The mobile device may provide a mobile subscriber identifier associated with a mobile network operator (MNO) that is different from the public WISP. The public WISP and MNO can coordinate the access credential so that the MNO is able to send the access credential to the mobile device if the MNO authorizes the use of the public WISP. The access credential may be sent using a messaging service, such as short message service (SMS). Using this technique, a subscriber of the MNO can obtain the AP access credential for the public WISP using a trustworthy delivery of the access credential by the MNO. The public WISP and MNO can monetize the internet access and authentication coordination workflow.

### TECHNICAL FIELD

This disclosure relates to the field of network communication, and more particularly to wireless internet service.

### DESCRIPTION OF THE RELATED TECHNOLOGY

An internet service provider (ISP) may be used by a mobile device to access the internet. A wireless ISP (WISP) is an organization that utilizes wireless technology (such as IEEE 802.11) for a connection between an access point and the mobile device. An access point may be associated with a wireless local area network (WLAN) that is communicatively coupled to the internet. A public WISP is an entity that operates at least one WLAN that is accessible by mobile devices within a public space. Examples of public WISPs may include those which operate at hotels, coffee shops, malls, airports, sports venues, and the like. Some public WISPs may provide free and open access without receiving compensation from the user. However, some public WISP may request compensation for providing wireless internet service. These public WISPs may attempt to obtain payment from the user at the time of usage or using a local billing procedure. Typically, public WISPs are localized, independent, or managed by local operators that are different from a mobile network operator.

A mobile network operator (MNO) is an entity that owns or operates a larger private infrastructure of elements used to sell and deliver mobile telecommunications services to a subscriber. For example, the MNO (which may be referred to as a wireless carrier, cellular company, or mobile network carrier) may own or operate radio spectrum allocation, cellular network infrastructure, back haul infrastructure, billing, customer care, provisioning computer systems and the like. The MNO traditionally sells a subscription for mobile telecommunications service. The subscription may include one or more of a call service, internet service, messaging service, roaming access (via another MNO), or the like.

### SUMMARY

The systems, methods, and devices of this disclosure each have several innovative aspects, no single one of which is solely responsible for the desirable attributes disclosed herein.

One innovative aspect of the subject matter described in this disclosure can be implemented by a first access point (AP) of a public wireless internet service provider (WISP). The first AP may receive a first mobile subscriber identifier for a first mobile device via a first wireless connection between the first mobile device and the first AP. The first wireless connection has a limit on an internet access for the first mobile device. The first AP may send the first mobile subscriber identifier to a first mobile network operator (MNO). The first AP may determine an access credential of the first AP that is available for distribution by the first MNO to the first mobile device via a messaging service of the first MNO. The first AP may receive the access credential from the first mobile device. The first AP may change the limit on the internet access via the first wireless connection in response to receiving the access credential from the first mobile device.

In some implementations, the first AP may create an authentication relationship between the first AP of the public WISP and an authentication server of the first MNO before sending the first mobile subscriber identifier to the first MNO.

In some implementations, creating the authentication relationship includes the first AP executing an application configured to communicate with the authentication server.

In some implementations, before receiving the first mobile subscriber identifier for the first mobile device, the first AP may establish the first wireless connection between the first mobile device and the first AP, and send a request for the first mobile subscriber identifier to the first mobile device.

In some implementations, the first AP may communicate the access credential between the first AP of the public WISP and the first MNO such that the first MNO authorizes the first mobile device to utilize the first AP by providing the access credential to the first mobile device.

In some implementations, the messaging service is a short messaging service (SMS).

In some implementations, determining the access credential includes receiving the access credential from an authentication server of the first MNO, wherein the access credential is specific to a subscriber of the first MNO that is associated with the first mobile subscriber identifier.

In some implementations, the first AP may send a temporary access credential to the first MNO with the first mobile subscriber identifier, wherein determining the access credential includes generating the temporary access credential in response to receiving the first mobile subscriber identifier.

In some implementations, the first AP may receive a policy configuration from the first MNO, and implement the policy configuration at the first AP.

In some implementations, the policy configuration includes at least one user-specific setting for a subscriber of the first MNO that is associated with the first mobile subscriber identifier.

In some implementations, the policy configuration includes at least one parameter set by the first MNO for all subscribers of the first MNO.

In some implementations, changing the limit on the internet access includes increasing the limit based, at least in part, on the policy configuration from the first MNO.

In some implementations, the first AP may implement a first virtual local area network (VLAN) at the first AP to separate data traffic for the first mobile device from a second VLAN for another device.

In some implementations, the first AP may measure a usage of the internet access, and provide accounting information to the first MNO, wherein the accounting information is based, at least in part, on the usage.

In some implementations, providing the accounting information includes sending the accounting information to an accounting server of the first MNO.

In some implementations, the first AP may receive a second mobile subscriber identifier for a second mobile device via a second wireless connection between the second mobile device and the first AP, wherein the second wireless connection has a limit on an internet access for the second mobile device. The first AP may send the second mobile subscriber identifier to a second MNO that is different from the first MNO. The first AP may determine a second access credential of the first AP that is available for distribution by the second MNO to the first mobile device via a messaging service of the second MNO. The first AP may receive the second access credential from the second mobile device. The first AP may change the limit on the internet access via the second wireless connection in response to receiving the second access credential from the second mobile device.

In some implementations, the first AP may establish a second wireless connection between a second mobile device and the first AP, wherein the second wireless connection has a limit on an internet access for the second mobile device. The first AP may receive the access credential from the second mobile device, wherein the access credential received from the first mobile device and the second mobile device is the same. The first AP may change the limit on the internet access via the second wireless connection in response to receiving the access credential from the second mobile device.

In some implementations, the first AP is a mobile AP.

In some implementations, the mobile AP is deployed in a vehicle.

In some implementations, the first AP is a mobile hotspot associated with a second mobile device having a mobile internet service from a second MNO that is different from the first MNO. The internet access for the first mobile device and the second mobile device may be provided by the mobile internet service from the second MNO.

Another innovative aspect of the subject matter described in this disclosure can be implemented in a mobile device. The mobile device may send a first mobile subscriber identifier for the first mobile device via a first wireless connection between the first mobile device and a first AP of a public WISP, wherein the first wireless connection has a limit on an internet access for the first mobile device. The mobile device may receive an access credential of the first AP via a messaging service of the first MNO. The mobile device may send the access credential from the first mobile device to the first AP to authenticate the first mobile device with the first AP. The mobile device may determine that the limit on the internet access via the first wireless connection has changed in response to sending the access credential from the first mobile device.

In some implementations, receiving the access credential includes receiving the access credential by a connection manager of the first mobile device, and sending the access credential includes automatically sending, by the connection manager, the access credential to the first AP.

In some implementations, receiving the access credential includes displaying the access credential on a display of the first mobile device.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 depicts a system diagram in which a public wireless internet service provider (WISP) authenticates a mobile device using access credentials provided via a mobile network operator (MNO).

FIG. 2 depicts a system diagram showing an example integration between a public WISP network and an MNO network.

FIG. 3 depicts a message flow diagram of public wireless internet service with authentication via an MNO.

FIG. 4 depicts a system diagram in which a public WISP can integrate with multiple MNOs.

FIG. 5 depicts a system diagram in which access credentials for a public WISP are utilized by multiple mobile devices.

FIG. 6 depicts a system diagram in which an public WISP operates multiple APs managed by a wireless local area network (WLAN) controller.

FIG. 7 depicts a system diagram showing additional integrations between a public WISP and MNO.

FIG. 8 depicts a system diagram in which data traffic separation is performed by an access point of a public WISP.

FIG. 9 depicts a system diagram in which a public WISP includes a mobile AP for use in a vehicle.

FIG. 10 depicts another system diagram in which a mobile AP in a vehicle utilizes a first MNO, and an access credential is provided via a second MNO associated with the subscriber of the mobile device.

FIG. 11 depicts a flowchart for an AP of a public WISP.

FIG. 12 depicts a flowchart for a mobile device.

FIG. 13 depicts a flowchart for an authentication server of an MNO.

FIG. 14 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Public wireless internet service providers (WISPs) are deploying wireless networks in more and more public spaces (such as hotels, coffee shops, malls, airports, sports venues, and the like). A mobile device can wirelessly connect to an access point (AP) of the WISP to obtain access to a wireless local area network (WLAN) that is communicatively coupled to the internet. A public WISP may secure the network so that it is available to authorized users while limiting access to unauthorized users. Rather than providing open (unauthenticated) access to the internet, a public WISP may implement an access credential on the AP. End devices that have the access credential can securely associate with the AP. In addition to authentication security, a public WISP may monetize the internet access that it provides. However, a user may appreciate an easier process to quickly connect and access the internet without performing multiple time-consuming steps associated with a financial transaction at the time of connecting.

A mobile network operator (MNO) may be capable of managing billing for internet access. For example, some MNOs may implement an authentication, authorization, and accounting (AAA) system. The MNO may sell internet access as a subscriber option and may be capable of accounting for data usage using the AAA system. However, there may be subscribers who utilize the MNO for voice calls or messaging without purchasing the internet access option. Alternatively, even if a subscriber has purchased an internet access option, there may be reasons to utilize a public WISP rather than the internet access provided by an MNO. For example, a subscriber may be traveling in a location which does not support internet access, or which provides slower internet access than is possible via the public WISP. Furthermore, there may be reasons for the MNO to encourage the use of public WISP when possible. For example, encouraging a subscriber to utilize the public WISP may help offload some traffic that would otherwise add to congestion of the MNO's wireless spectrum. The MNO may be capable of compensating the public WISP for the usage of the public WISP's network. The MNO may bill some or all of the costs for utilizing the public WISP to the subscriber. Therefore, integrating the MNO subscription and billing platform to support authentication of a subscriber to a public WISP may benefit the MNO, the public WISP, and the subscriber.

In one aspect, an AP of a public WISP may receive, from a mobile device, a mobile telephone number (or other identifier) associated with a subscriber of an MNO. The public WISP can be integrated with the MNO so that the MNO can authorize the subscriber to utilize the public WISP. The MNO may send an access credential (such as a passphrase or key) to the mobile device associated with the mobile telephone number. For example, the MNO may utilize a messaging service, such as short messaging service (SMS), to send the access credential to the mobile device. The concepts of this disclosure may be useful to an end user that may not presently have (or has not subscribed) to an internet service of the MNO but which can receive an SMS message from the MNO. In some implementations, the MNO or the public WISP may generate a temporary access credential and communicate the temporary access credential to the mobile device via the MNO's messaging service. The mobile device can utilize the access credential to authenticate with the AP and obtain internet access via the public WISP. For example, a connection manager at the mobile device may process the SMS message to automatically retrieve the access credential from the SMS message and submit the access credential to the AP without user interaction. Alternatively, a user may view the access credential from the SMS and manually enter the access credential to initiate the authenticated wireless association. After receiving the access credential at the mobile device, it may be possible to use the access credential on another device (either for the same user or for other users). For example, the user may choose to provide the credential to other people so that other people can authenticate with the AP, sharing the user's billing relationship with the MNO.

In another aspect, this disclosure describes an onboarding process that could be used to integrate the public WISP with an MNO. For example, the public WISP may provide subscriber set identifiers (SSIDs) of the APs operated by the public WISP. The MNO may generate a list of known APs which are capable of providing local internet access for subscribers of the MNO. The onboarding process also may include the exchange of configuration settings or other parameters. In some implementations, the public WISP can provide accounting information (such as billing or usage information) regarding a user session to the MNO. A public WISP can coordinate with multiple MNOs to monetize the internet access provided by the public WISP.

In another aspect, the MNO also can send user-specific parameters (such as security, usage, or limitations) to the public WISP for use at the AP or another element in the public WISP network. The user-specific parameters may be sent in response to the request for access from the mobile device or may be sent during an onboarding process. For example, the AP can create a virtual local area network (VLAN) associated with the subscriber to enforce the user-specific parameters and to segment the user's traffic from other customers of the public WISP.

In another aspect, the concepts in this disclosure can be extended to a variety of APs, including mobile APs (such as mobile hotspots and in-vehicle APs). For example, using these techniques, an operator of a mobile AP may permit access to its upstream internet access to be used by a subscriber of the MNO. In another example, a first user can utilize the mobile AP to access a cellular data service of a second user associated with the mobile AP.

Particular implementations of the subject matter described in this disclosure can be implemented to realize one or more of the following potential advantages. A subscriber of an MNO can quickly and easily obtain an access credential associated with an AP of a public WISP. The MNO can monetize the authentication process and provide billing services. The public WISP can monetize the internet access by integrating with the MNO with easier transactions for billing and usage for a subscriber of the MNO.

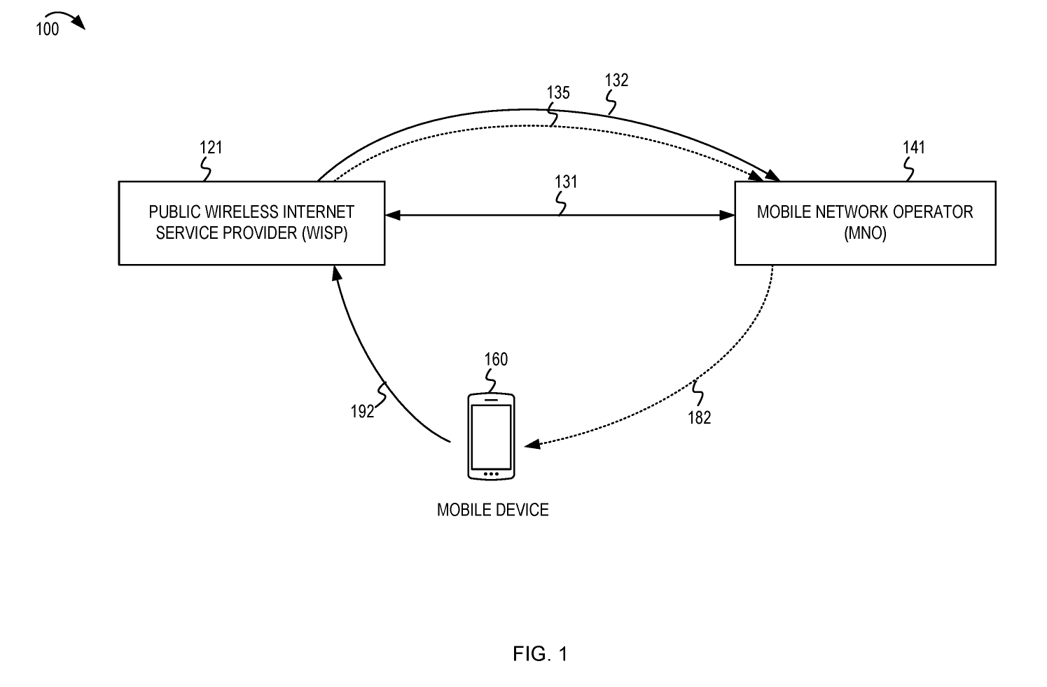

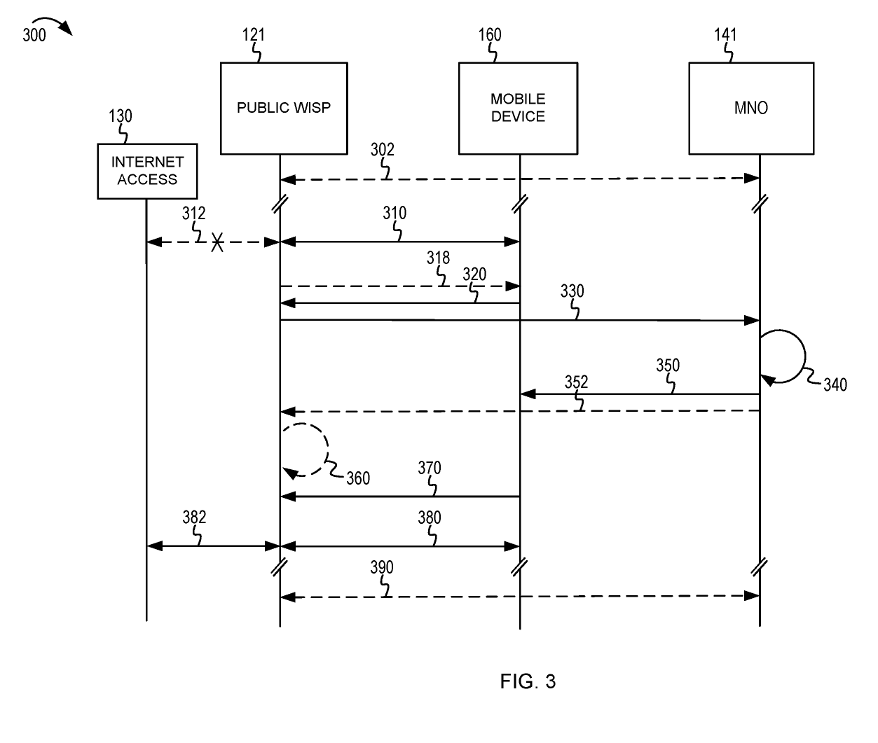

FIG. 1 depicts a system diagram in which a public WISP authenticates a mobile device using access credentials provided via an MNO. The system 100 includes a public WISP 121 and an MNO 141. A communications connection 131 exists between the public WISP 121 and the MNO 141. For example, the communications connection 131 may include a secure session over the internet or a private network connection between the public WISP 121 and the MNO 141. The communications connection 131 can be used by the public WISP 121 and the MNO 141 to communicate regarding an access credential 135 that is available for distribution by the MNO 141 if the MNO 141 authorizes a subscriber to utilize the public WISP 121. In some implementations, the access credential 135 may be communicated to the MNO 141 during an onboarding process. The onboarding process will be further described below with regard to FIG. 3.

The system 100 also depicts a mobile device 160. The mobile device 160 may be associated with a subscriber of the MNO 141. In the example of FIG. 1, the mobile device 160 is within a wireless coverage area (not shown) provided by the public WISP 121. For example, the mobile device 160 may be within range to communicate with a first AP (not shown) in the public WISP network. As described above, the public WISP may operate one or more APs in a public space such as a hotel lobby, coffee shop, restaurant, airport, bus terminal, sports venue, or the like. The public WISP 121 may provide limited (or no) network access for the mobile device 160 until the mobile device 160 has authenticated using an authorized access credential. For example, the public WISP 121 may limit internet access to a web site associated with the public WISP 121 or to a billing and authentication page. Traditional public ISPs may attempt to obtain payment or a billing account to be established before providing additional internet access to the mobile device 160. However, this can be time-consuming or frustrating for a user of the mobile device 160.

In accordance with this disclosure, the mobile device 160 may avoid some traditional payment or billing hurdles by utilizing an authorized access credential provided by the MNO 141. In the example of FIG. 1, the mobile device 160 may provide a mobile subscriber identifier (such as a mobile telephone number (MTN), international mobile equipment identity (IMEI) number, subscriber identification module (SIM) number, or the like). In some implementations, the mobile device 160 may indicate to which MNO it is subscribed. Alternatively, the public WISP 121 may perform a lookup to determine which MNO is associated with the mobile subscriber identifier. The mobile subscriber identifier may be a globally unique identifier that identifies the subscriber's mobile device. Typically the mobile subscriber identifier is associated with a primary MNO, to which the subscriber pays for the services in its plan. However, the mobile subscriber identifier also may be used by other MNOs such as when the mobile device 160 is roaming on a secondary MNO that has a roaming agreement with the primary MNO.

The public WISP 121 may send the mobile subscriber identifier 132 to the MNO 141. If the authorized access credential has not previously been provided to the MNO 141, the public WISP 121 also may send the authorized access credential 135. The access credential 135 may be sent with or separately from the mobile subscriber identifier 132. In some implementations, the access credential 135 is unique for the mobile device 160. For example, the public WISP 121 may generate the access credential 135 in response to receiving the mobile subscriber identifier from the mobile device 160. In other implementations, as described in FIG. 3, the MNO 141 may generate a temporary access credential and provide it to the public WISP 121. Regardless of how the access credential is generated and shared, the result is that the access credential is known to both the public WISP 121 and the MNO 141. By agreement, the MNO 141 can provide the authorized access credential 182 to the mobile device 160 if the MNO 141 authorizes the mobile device 160 to utilize the public WISP 121. For example, the MNO 141 may have a billing arrangement to bill for public wireless internet service on behalf of the public WISP 121. Alternatively, the MNO 141 may have a roaming agreement with the public WISP 121 under which the MNO 141 has contracted for one or more subscribers to utilize the public WISP 121.

In some implementations, the mobile device 160 may receive the authorized access credential 182 via a messaging service of the MNO 141 (rather than a packet data service). For example, the mobile device 160 may not presently have access to the packet data service due to location, subscription plan limitation, interference, or the like. However, the messaging service may be available. An example of a messaging service is short messaging service (SMS), which can take the form of a text message. The authorized access credential 182 may be provided as a text message or may otherwise be included in a data portion of an SMS message. Having received the authorized access credential 182 from the MNO 141, the mobile device 160 can utilize the authorized access credential to authenticate with the public WISP 121. For example, a connection manager (or other application) on the mobile device 160 may receive the authorized access credential 182 and automatically send the access credential to the first AP. For example, the connection manager may operate as a background process to monitor for the authorized access credential 182. In some implementations, the connection manager may send the access credential to the public WISP 121 without user interaction. In other implementations, the mobile device 160 may display the received authorized access credential 182 on a display of the mobile device 160. A user may copy and paste the access credential from the text message to another prompt to send the access credential to the public WISP 121 for authentication.

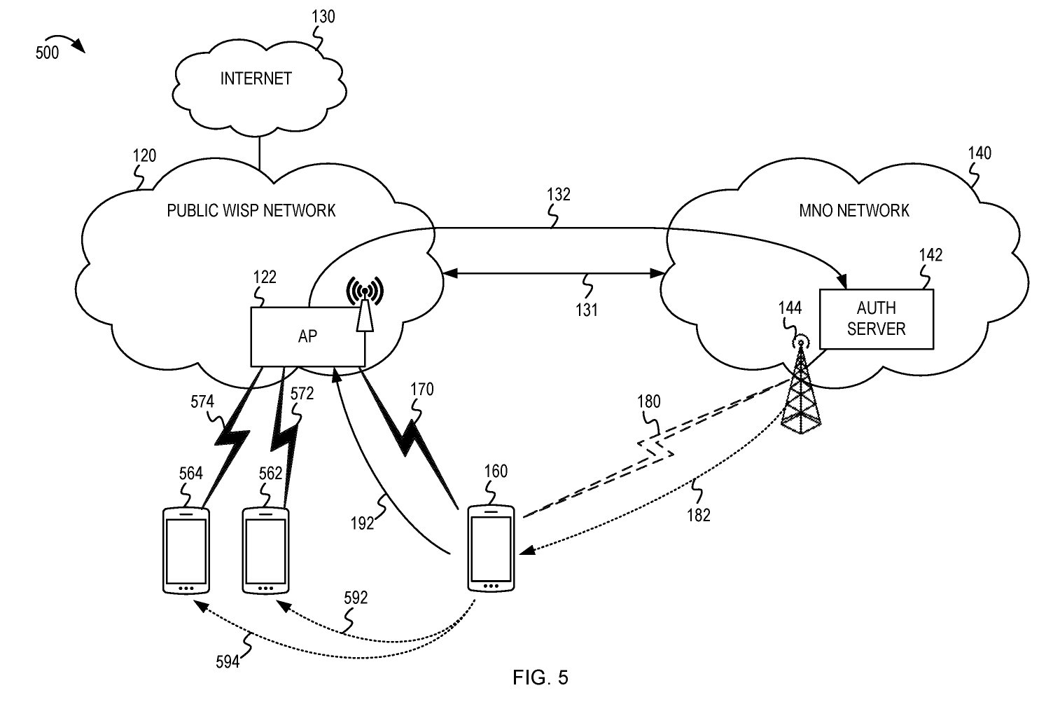

The access credential may take the form of a passphrase, key, or other data which can be used to authenticate with the public WISP 121. In some implementations, as described in more detail in FIG. 5, a user of the mobile device 160 may choose to share the access credential with other users or other devices. If the access credential uniquely identifies the subscriber associated with the mobile device 160, the public WISP 121 can measure the data usage by one or more devices using the access credential and report accounting information to the MNO 141 based on the data usage. For example, the accounting information may include an amount of internet access (by time or transmitted data) or may indicate a billing charge associated with the mobile device 160 (and approved other devices) utilizing the public WISP 121. Thus, in some implementations, the public WISP 121 may be compensated by the MNO 141 based on the accounting information. The MNO 141 may be configured to bill the subscriber based on the accounting information.

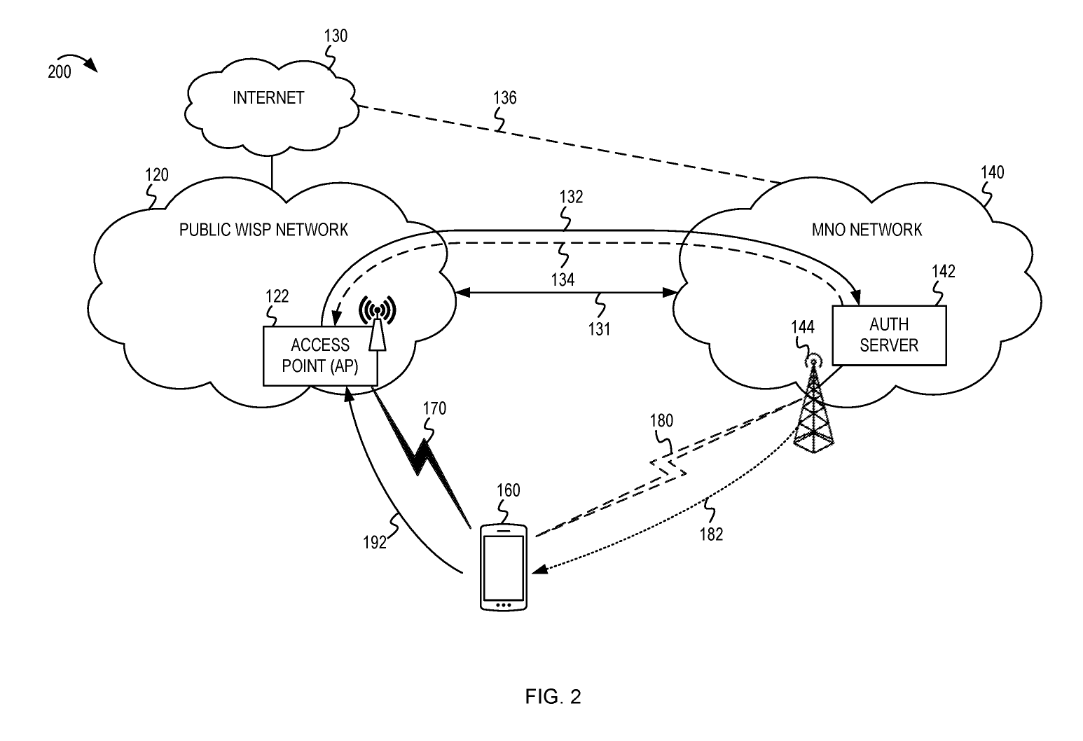

FIG. 2 depicts a system diagram showing an example integration between a public WISP network and an MNO network. The system 200 includes a public WISP network 120, an MNO network 140, and the internet 130. The public WISP network 120 includes an AP 122 which can provide wireless access for the mobile device 160 to the public WISP network 120. The public WISP network 120 is communicatively coupled to the internet 130. The public WISP network 120 also has a communications connection 131 to the MNO network 140 as described previously in FIG. 1. In some implementations, the communications connection 131 may include a secure session that traverses the internet 130 and a connection 136 between the internet 130 and the MNO network 140.

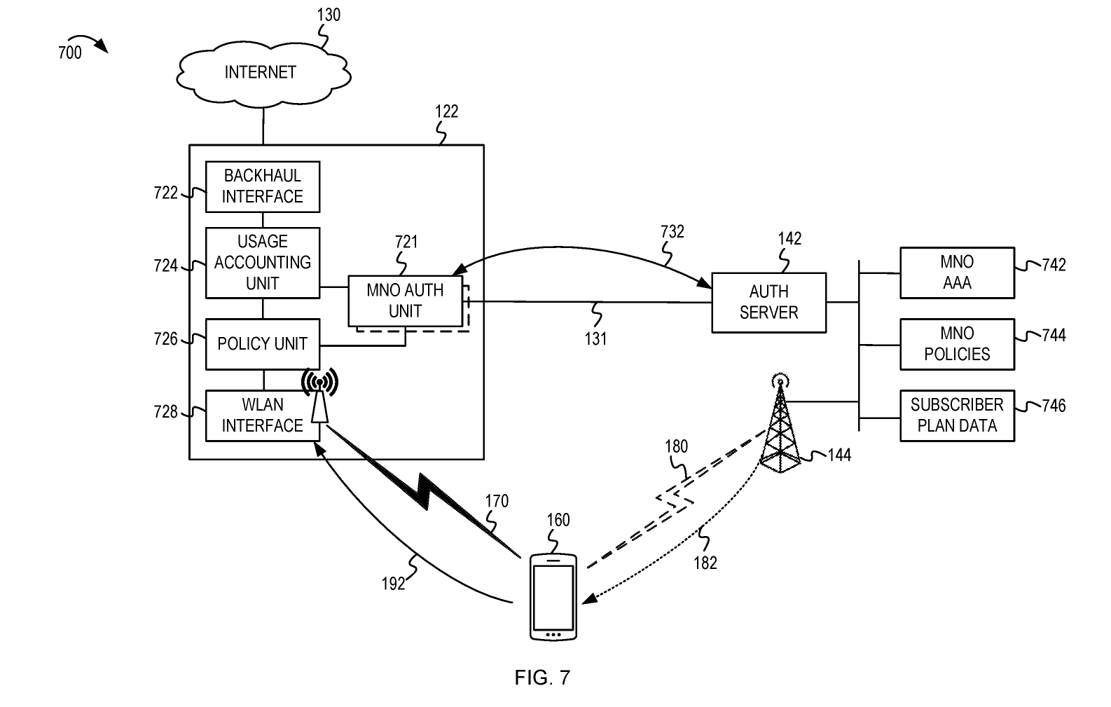

The MNO network 140 includes an authentication server 142 which can communicate with one or more elements in the public WISP network 120. For example, as depicted in FIG. 2, the authentication server 142 maybe capable of receiving a mobile subscriber identifier 132 from the AP 122. In other implementations, the AP 122 may provide the mobile subscriber identifier to a WLAN controller (not shown) in the public WISP network 120, which in turn sends the mobile subscriber identifier to the authentication server 142. In some implementations, the authentication server 142 may send a response 134 to the AP 122. For example, the response 134 may acknowledge receipt of the mobile subscriber identifier 132. In some implementations, the response 134 also may provide a policy configuration to the AP 122. For example, the policy configuration may have one or more user-specific settings for a subscriber. The policy configuration may include a parameter set by the MNO for subscribers that use the public WISP network 120. Policy configurations are described further in FIG. 7 below.

The authentication server 142 also may communicate with one or more elements in the MNO network 140, such as a radio base station 144. The radio base station 144 may be within range to communicate via a messaging service 180 to the mobile device 160. The authentication server 142 may cause the radio base station 144 to send the authorized access credential 182 in a message (such as an SMS text message) to the mobile device 160. The mobile device 160 can use the authorized access credential 192 to authenticate with the AP 122. Upon completing the authentication, the AP 122 may enable internet access for the mobile device 160 via the AP 122. For example, the mobile device 160 may use an authenticated wireless connection 170 to communicate to the AP 122. The AP 122 may route traffic between the mobile device 160 and the internet 130.

FIG. 3 depicts a message flow diagram of public wireless internet service with authentication via an MNO. The flow diagram 300 shows the public WISP 121, the mobile device 160, and the MNO 141 as described previously. For example, the public WISP 121 may operate a public WISP network with one or more APs (not shown), such as the public WISP network 120 and the AP 122 of FIG. 2. Similarly, the MNO 141 may operate an MNO network and authentication server (not shown, such as the MNO network 140 and the authentication server 142).

At 302, the public WISP 121 and the MNO 141 may establish a relationship, which may include an onboarding process. In some implementations, the onboarding process may be performed before the public WISP 121 is capable of using authentication supported by the MNO. In other implementations, the onboarding process may be performed in real-time or in response to a connection request from the mobile device 160. Examples of the onboarding process may include the public WISP 121 (such as an AP in the public WISP 121) installing or executing an application that communicates with an authentication server of the MNO 141. The application may be unique for each MNO or may be common for multiple MNOs. The application may describe the public WISP 121, such as coverage areas, SSIDs for the APs operated by the public WISP 121, and the like. The application also may retrieve a common MNO-provided configuration that should be used for subscribers of the MNO. The application may also provide information about the APs of the public WISP 121. For example, the application may provide a list of SSIDs or other hotspot identification, channel, geography, or the like. The MNO 141 may determine if the list of SSIDs are in a known list of public WISPs that are available to subscribers of the MNO 141. If not, the MNO 141 may perform a registration of the public WISP 121, which may include adding the APs to the known list.

At some point when the mobile device 160 is within a wireless coverage area of the public WISP 121, the mobile device 160 may establish a first wireless connection 310 with an AP (not shown) of the public WISP 121. The first wireless connection 310 may initially provide limited or no access 312 to the internet 130. At 320, the mobile device 160 may provide a mobile subscriber identifier associated with the mobile device 160. For example, the mobile device 160 may provide the mobile subscriber identifier in response to a query 318 from the public WISP 121. At 330, the public WISP 121 may provide the mobile subscriber identifier to the MNO 141 to indicate that the mobile device 160 is attempting to access the internet via the public WISP 121. At 340, the MNO 141 may determine whether or not to authorize the mobile device 160 to access the internet via the public WISP 121. For example, the MNO 141 may check subscriber plan data for a subscriber associated with the mobile subscriber identifier to see if the subscriber is authorized the use the public WISP 121. The MNO 141 may authorize the use based on a network-wide agreement with the public WISP 121 or may authorize the use on a per-subscriber basis. For example, the subscriber plan data may indicate whether the subscriber has paid (or agrees to be billed) for usage associated with the public WISP 121. If the MNO 141 determines that the mobile device 160 is authorized to use the public WISP 121, the MNO 141 may send an access credential 350 to the mobile device 160. The access credential 350 may be provided in a message directed to the mobile device 160 based on the mobile subscriber identifier. For example, if the mobile subscriber identifier is a mobile telephone number, an SMS text message containing the access credential 350 can be sent to the mobile telephone number. Thus, the MNO 141 can determine whether the subscriber is authorized and can provide the access credential directly to the subscriber using the mobile subscriber identifier provided at 330.

In some implementations, the MNO 141 also may communicate an authorization or other information to the public WISP 121 via a response 352. The response 352 may include configuration settings, parameters, or the like. In some implementations, the response 352 may include a temporary access credential generated by the MNO 141 that is specific to a subscriber associated with the mobile subscriber identifier. If so, at 360, the public WISP 121 may configure an AP to accept the temporary access credential or other configuration settings provided in the response 352.

After receiving the access credential 350, the mobile device 160 can use the access credential to authenticate 370 to the public WISP 121. For example, the mobile device 160 can use the access credential as an authentication key or passphrase to create a secure wireless association with an AP of the public WISP 121. Once the mobile device 160 has used the access credential to authenticate to the public WISP 121, the public WISP 121 may change the first wireless connection 380 to enable internet access 382.

At 390, the public WISP 121 may communicate accounting information (such as usage or billing) to the MNO 141. The MNO 141 may acknowledge and record the accounting information. For example, the MNO 141 may implement an AAA system (not shown) to store the accounting information. A billing system (not shown) may retrieve data from the AAA system to generate billing to the subscriber, or to pay the public WISP 121 for the usage, or both.

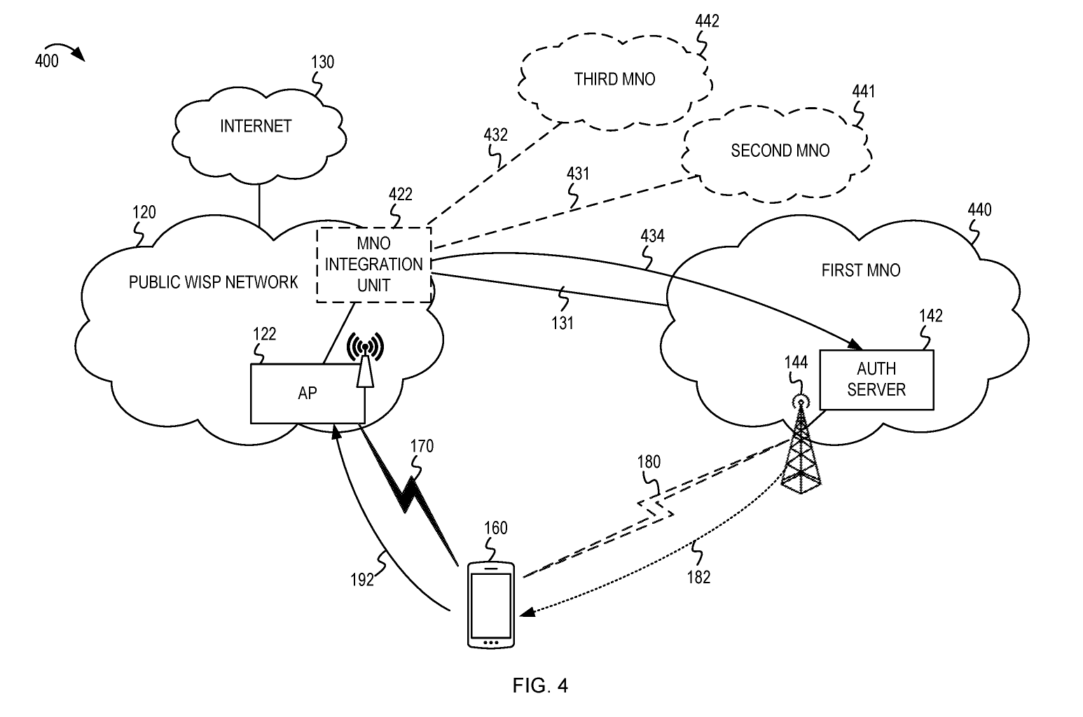

FIG. 4 depicts a system diagram in which a public WISP can integrate with multiple MNOs. The system 400 includes similar features previously described with regard to FIG. 2. For example, the system 400 includes the public WISP network 120, the AP 122, the internet 130, and the mobile device 160. The public WISP network 120 may include an MNO integration unit 422. The MNO integration unit 422 may be in a standalone hardware, such as a WLAN controller (not shown) or other server in the public WISP network 120. Alternatively, the MNO integration unit 422 may be implemented in the AP 122. The MNO integration unit 422 may execute an application to establish the communications connection 131 to a first MNO 440. As described in FIG. 2, the first MNO 440 has an authentication server 142 and a radio base station 144 capable of communicating via a messaging service 180 to the mobile device 160. However, in FIG. 4, it is recognized that the public WISP can integrate with multiple MNOs. In addition to the first MNO 440, the MNO integration unit 422 may establish communication connections 431, 432 to a second MNO 441 and third MNO 442, respectively. Upon receiving a mobile subscriber identifier from the mobile device 160, the AP 122 may communicate the mobile subscriber identifier to the MNO integration unit 422. If the mobile device 160 does not identify the MNO at which it is subscribed, the MNO integration unit 422 may perform a reverse lookup using the mobile subscriber identifier to determine which MNO should receive the mobile subscriber identifier 434. In the example of FIG. 4, the MNO integration unit 422 sends the mobile subscriber identifier 434 to the authentication server 142 of the first MNO 440. The remaining features of FIG. 4, including the authorized access credential 182, the authorized access credential 192, and the authenticated wireless connection 170, are identical to those described in FIG. 2.

It bears stating again that the MNO integration unit 422 may integrate multiple MNOs, each of which may have different policy configurations. During onboarding of the MNO, the MNO integration unit 422 may receive settings from the MNOs that are to be implemented at the AP 122. Additionally, after sending the mobile subscriber identifier 434 to the authentication server 142 at the first MNO 440, the MNO integration unit 422 may receive subscriber-specific configurations (or a temporary access credential) provided by the authentication server 142. Each MNO may have different implementations of the authentication server 142 and protocols between the MNO integration unit 422 and their respective authentication servers.

FIG. 5 depicts a system diagram in which access credentials for a public WISP are utilized by multiple mobile devices. The system 500 includes similar features as described with regard to FIG. 2. For example, the system 500 includes the public WISP network 120, the AP 122, the internet 130, the mobile device 160, the communications connection 131 to the MNO network 140, the authentication server 142 and the radio base station 144. Just as described above, the mobile device 160 provides its mobile subscriber identifier to the AP 122, and the AP 122 provides the mobile subscriber identifier 132 to the authentication server 142. The authentication server 142 sends an authorized access credential 182 via the messaging service 180 to the mobile device 160. The mobile device 160 can use the authorized access credential 192 to establish the authenticated wireless connection 170 with the AP 122.

However, a user of the mobile device 160 may choose to share the access credential with another user or another device. For example, the mobile device 160 may send the access credential 592 to a second mobile device 562. The second mobile device 562 may be another device owned or operated by the user of the mobile device 160 but which may not have a separate subscription plan with the MNO network 140. The second mobile device 562 may use the access credential to establish an authenticated wireless connection 572 to the AP 122. Alternatively, the user of the mobile device 160 may provide the access credential 594 to a third mobile device 564 which may belong to another user (regardless of whether the other user has a subscription with the MNO network 140, another MNO, or neither). The third mobile device 564 may use the access credential 594 to establish an authenticated wireless connection 574 to the AP 122.

There may be different ways for the user of the mobile device 160 to provide the access credential to the second mobile device 562 or third mobile device 564. For example, the mobile device 160 may display the access credential on a display which is read by another user. The mobile device 160 may display a barcoded image encoding the access credential which can be scanned and decoded by the second mobile device 562 or the third mobile device 564. Alternatively, the mobile device 160 can send a message (such as an SMS text message) containing the access credential to the second mobile device 562 or the third mobile device 564.

In implementations where the access credential provided by the authentication server 142 is unique to the subscriber, the accounting information based on usage can include usage by the mobile device 160 as well as the second mobile device 562 and the third mobile device 564. For example, if a group of three coworkers are traveling for work and would like to use a public WISP network 120, it may be possible for a first coworker (using the mobile device 160) to obtain the access credential on behalf of the group. The coworkers can share the access credential so that each of them can quickly and easily establish wireless connectivity (using the access credential on the mobile device 160, the second mobile device 562, and the third mobile device 564) to the AP 122 for internet access. The usage for the group may be collectively accounted at the MNO network 140 as usage for the subscription plan of the first coworker.

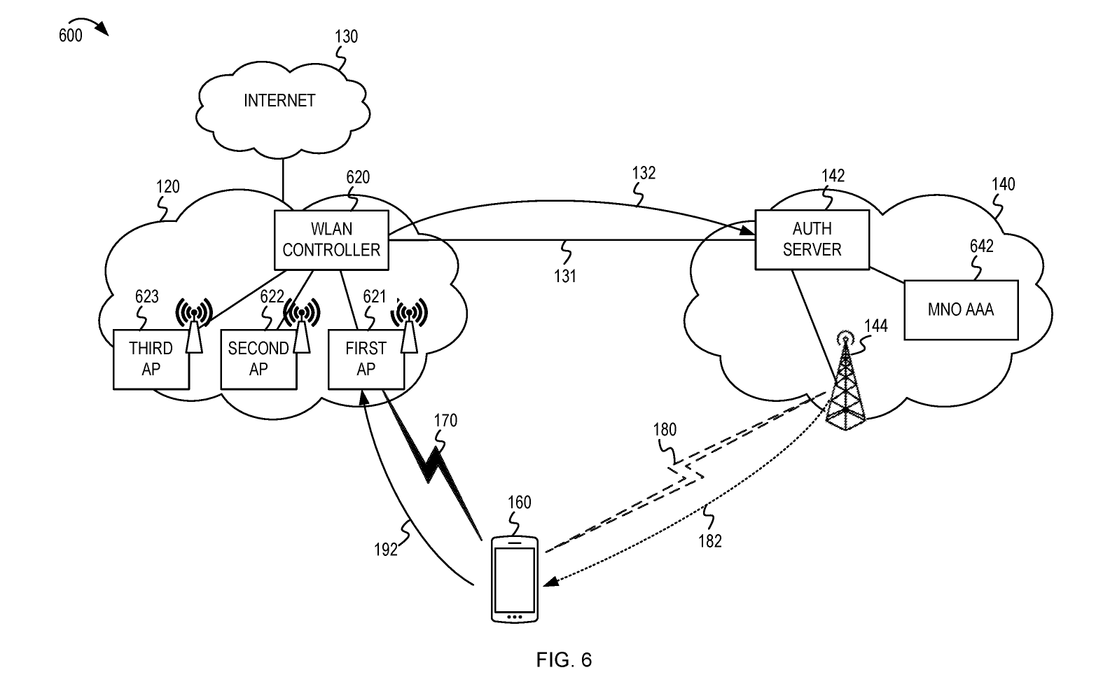

FIG. 6 depicts a system diagram in which a public WISP operates multiple APs managed by a wireless local area network (WLAN) controller. The system 600 includes similar features as described with regard to FIG. 2. For example, the system 600 includes the public WISP network 120, the internet 130, the mobile device 160, the communications connection 131 to the authentication server 142 of the MNO network 140, and the radio base station 144. FIG. 6 also depicts an MNO AAA system 642 at the MNO network 140 that can record the accounting information and interface with a billing system (not shown) at the MNO network 140. Different from FIG. 2, the system 600 shows that the public WISP network 120 may operate multiple APs, including a first AP 621, a second AP 622, and a third AP 623. As an example scenario, the APs may be deployed at each coffee shop of a chain of coffee shops. A WLAN controller 620 may manage the configuration and connectivity for each of the APs 621, 622, 623.

As described above the integration between the public WISP network 120 and the MNO network 140 may include an onboarding process. The onboarding process may involve the installation and execution of an application that is configured to communicate with the authentication server 142. In some implementations, the application may be executed at each of the APs 621, 622, 623 (or particular ones of the APs). For example, the WLAN controller 620 may retrieve the application and cause the application to be installed and executed at the APs. In other implementations, the application may be executed by the WLAN controller 620 or another server (not shown) in the public WISP network 120. An application repository may be provided by the MNO network 140, such as at the authentication server 142 or another server (not shown) in the MNO network 140. The application repository may provide an application that is customized or specific to the MNO network 140. Alternatively, the application repository may be outside of the MNO network 140 and may be used by multiple MNOs as a common application platform.

The application either at the APs 621, 622, 623 or at the WLAN controller 620 may provide SSID information, geographic location data, wireless capability information, or a listing of services supported by the APs 621, 622, 623 to the authentication server 142. The application also may implement security or other policies set by the MNO network 140, such as a limit on the length of a data session, usage limits or throttles, passphrase mappings, or other mobile network settings.

Once the first AP 621 has been configured by the WLAN controller 620 during the onboarding process, the first AP 621 may be ready to receive the mobile subscriber identifier from the mobile device 160. Just as described above, the mobile device 160 provides its mobile subscriber identifier to the first AP 621, and the first AP 621 provides the mobile subscriber identifier 132 to the authentication server 142 (either directly or via the WLAN controller 620). The authentication server 142 sends an authorized access credential 182 via the messaging service 180 to the mobile device 160. The mobile device 160 can use the authorized access credential 192 to establish the authenticated wireless connection 170 with the first AP 621. In some implementations, the same access credential 192 may be used by the mobile device 160 to establish authenticated wireless connections (not shown) with another AP in the public WISP network 120. For example, the same access credential 192 may be accepted by the second AP 622 or the third AP 623 if they share the same credentials or authentication technique as the first AP 621.

FIG. 7 depicts a system diagram showing additional integrations between a public WISP and MNO. For brevity, the system 700 depicted in FIG. 7 has removed some of the networks and connections that were in FIG. 2. However, the system 700 shows the AP 122 of a public WISP network 120 (not shown) and the authentication server 142 of the MNO network 140 (not shown) as described in FIG. 2. The AP 122 is capable of providing an authenticated wireless connection 170 for the mobile device 160 upon receiving the authorized access credential 192 from the mobile device 160. As described above, the mobile device 160 obtains the authorized access credential 182 via a messaging service 180 of the MNO. The radio base station 144 of the MNO network 140 is shown for consistency with the previous figures.

In FIG. 7, the AP 122 is described as having several components including a WLAN interface 728, a policy unit 726, a usage accounting unit 724 and a backhaul interface 722. The WLAN interface 728 is capable of establishing the authenticated wireless connection 170 with the mobile device 160. The backhaul interface 722 provides the backhaul network connection to the internet 130. Other network elements (not shown) may be between the AP 122 and the internet 130, such as a router, gateway, modem, or the like. The AP 122 also includes an MNO authentication unit 721. The MNO authentication unit 721 is configured to communicate with the authentication server 142, such as to provide the mobile subscriber identifier or to receive profile settings from the authentication server 142. As stated above, there may be more than one MNO authentication unit 721, such as when the AP 122 is integrated with multiple MNOs. At the MNO side, the MNO may include an MNO AAA system 742, one or more MNO policies 744, and subscriber plan data 746. At the time of authorization, or during onboarding, the authentication server 142 may send the MNO policies 744 to the MNO authentication unit 721. The MNO authentication unit 721 may implement the MNO policies 744 using the policy unit 726. For example, the policy may include filtering, limiting, tagging, or the like. When the authentication server 142 receives the mobile subscriber identifier (at 732) from the MNO authentication unit 721, the authentication server 142 may review the subscriber plan data 746 to determine if the mobile device 160 is authorized to use the AP 122. The authentication server 142 may send a response (also at 732) to indicate whether the subscriber was authorized and may include all or a portion of the MNO policies 744 based on the subscriber plan data 746.

At the AP 122 the usage accounting unit 724 may measure and record the usage by the mobile device 160. After the mobile device 160 has dropped the authenticated wireless connection 170, or in accordance with a periodic schedule, the MNO authentication unit 721 may retrieve accounting information from the usage accounting unit 724 and send it to the MNO AAA system 742 for recording or billing.

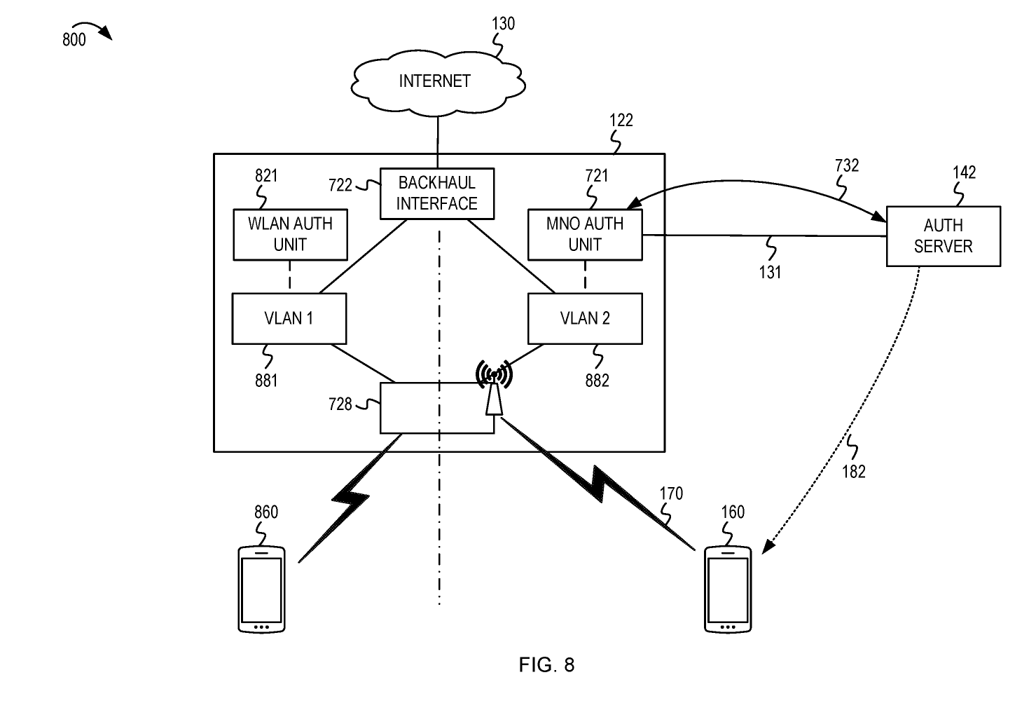

FIG. 8 depicts a system diagram in which data traffic separation is performed by an access point of a public WISP. For brevity, the system 800 depicted in FIG. 8 has removed some of the networks and connections that were in FIG. 2. However, the system 800 shows the AP 122 of a public WISP network 120 (not shown), the authentication server 142 of the MNO network 140 (not shown), the communications connection 131 between the MNO authentication unit 721 and authentication server 142, as described in FIGS. 2 and 7. The AP 122 is capable of providing an authenticated wireless connection 170 for the mobile device 160 upon receiving the authorized access credential 192 (not shown) from the mobile device 160. As described above, the mobile device 160 obtains the authorized access credential 182 via a messaging service 180 (not shown) of the MNO.

In FIG. 8, the AP 122 is depicted with detail to show data traffic separation. The WLAN interface 728 may provide more than one SSID or may be capable of separating data traffic based on a device identifier (such as a media access control, MAC, address) of the mobile device 160. In FIG. 8, a second mobile device 860 is shown. The second mobile device 860 may be associated with a different MNO or may be a direct customer of the public WISP. At the WLAN interface 728, the data traffic for the second mobile device 860 and the mobile device 160 may be tagged as belonging to separate virtual local area networks (VLANs), such as a first VLAN 881 and a second VLAN 882, respectively. The MNO authentication unit 721 may be associated with forwarding the mobile subscriber identifier and managing the communications to and from the authentication server 142 of the MNO. A WLAN authentication unit 821 may be associated with authenticating devices for the first VLAN 881, such as the second mobile device 860. Once the data traffic has been segregated (and tagged) into the separate VLANs 881, 882, the AP 122 can route and forward the data traffic via the backhaul interface 722 to upstream network elements (not shown).

There may be many VLANs implemented by the AP 122. The VLANs may be specific to each MNO or even for each mobile device. The VLANs may be used to implement the different policies or profile settings as described above. In some instances, a VLAN may be used to enable group communication among a group of mobile devices that have wireless connections to the AP 122, while keeping the data traffic for the group communication separate from other mobile devices utilizing the AP 122 for access to the internet 130.

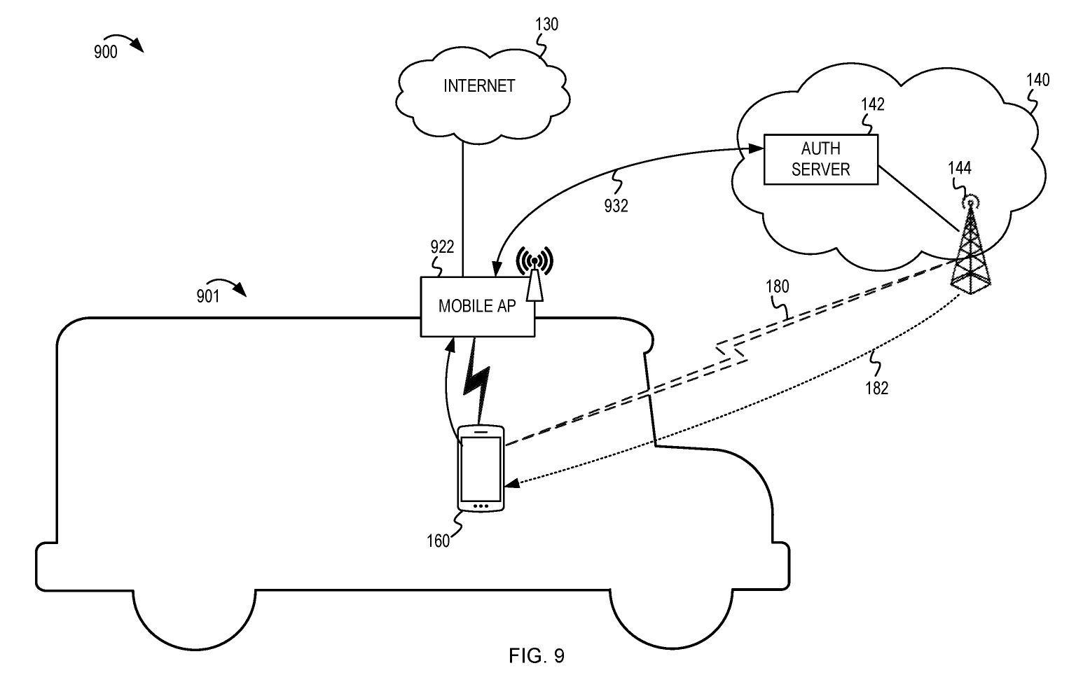

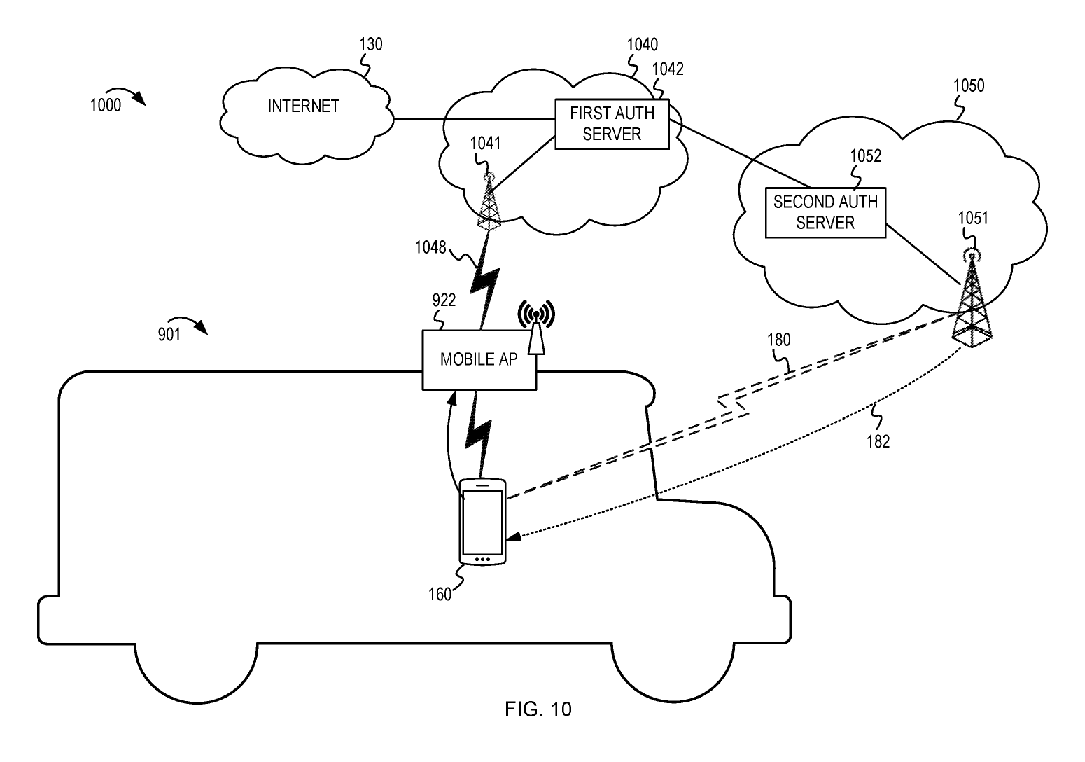

FIG. 9 depicts a system diagram in which a public WISP includes a mobile AP for use in a vehicle. The system 900 shows a vehicle 901 in which there is a mobile AP 922. The mobile AP 922 may provide access to the internet 130. The mobile AP 922 may be a mobile hotspot or the like. For example, the mobile AP 922 may obtain access to the internet 130 using a packet data service from an MNO (as discussed in FIG. 10), via a satellite packet data service, via a wireless mesh network, or the like. Similar to FIG. 2, the mobile AP 922 can communicate with the authentication server 142 of the MNO network 140. The mobile AP 922 may provide the mobile subscriber identifier of the mobile device 160 to let the authentication server 142 know that the mobile device 160 is requesting an authorized access credential from the MNO network 140. The MNO network 140 may send the authorized access credential 182 via a messaging service 180 (from the radio base station 144) to the mobile device 160. The mobile device 160 can use the access credential to establish an authenticated wireless connection to the mobile AP 922 and to access the internet 130 via the mobile AP 922.

In FIG. 9, the vehicle 901 is depicted conceptually as a bus. However, the concepts of this disclosure may be used for any variety of vehicles, such as planes, trains, buses, cars, boats, and the like. In one hypothetical scenario, the vehicle may be a taxi for public transportation and may offer the use of the mobile AP 922 to customers of the taxi based on a relationship with the MNO network 140.

FIG. 10 depicts another system diagram in which a mobile AP in a vehicle utilizes a first MNO and an access credential is provided via a second MNO associated with the subscriber of the mobile device. The system 1000 of FIG. 10 is similar to the system 900 described in FIG. 9, including the vehicle 901, the mobile device 160, the mobile AP 922, the messaging service 180, and the authorized access credential 182. However, FIG. 10 describes an implementation in which the mobile AP 922 obtains upstream network access using a packet data service 1048 provided by a base station 1041 of a first MNO 1040. Meanwhile the mobile device 160 may belong to a subscriber of a second MNO 1050. In this example, it may be possible for the first MNO 1040 to coordinate authentication and accounting using a first authentication server 1042 of the first MNO 1040 communicating with a second authentication server 1052 of the second MNO 1050. As described above, the mobile AP 922 may allow packet data access for the mobile device 160 after receiving an authorized access credential from the mobile device 160. However, in FIG. 1000, it is recognized that the first authentication server 1042 and the second authentication server 1052 could coordinate to produce and authorize the access credential. Furthermore the first MNO 1040 and the second MNO 1050 could establish interesting cross-MNO monetization opportunities. For example, the first MNO 1040 could deploy the mobile AP 922 and provide it as a roaming access network which one or more subscribers of the second MNO 1050 could utilize. The billing for usage of the mobile AP 922 could be distributed to the second MNO 1050 or any other MNOs which contract to use the mobile AP 922 as a roaming access network. However, the second MNO 1050 (or other MNOs) could retain control over which users are authorized to use the mobile AP 922 by only providing access credentials to certain subscribers (based on priority, subscriber plan, payment history, or the like).

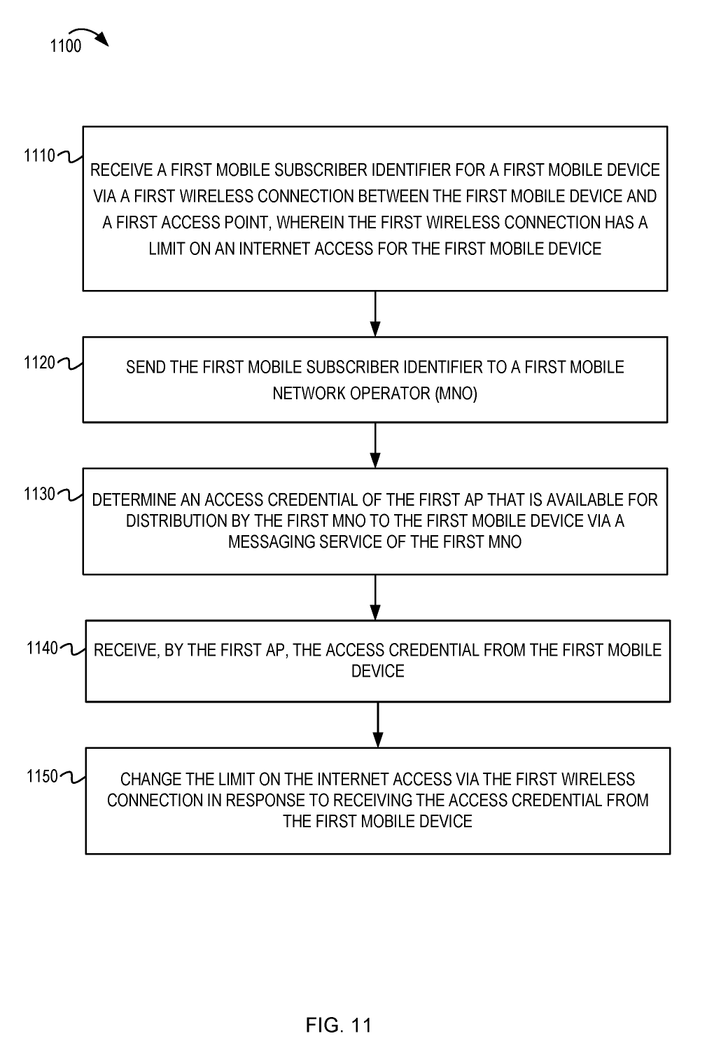

FIG. 11 depicts a flowchart for an AP of a public WISP. The flowchart 1100 begins at block 1110. At block 1110, the AP may receive a first mobile subscriber identifier for a first mobile device via a first wireless connection between the first mobile device and the AP. The first wireless connection may initially have a limit on an internet access for the first mobile device. At block 1120, the AP may send the first mobile subscriber identifier to a first MNO. For example, the AP may perform a reverse lookup to identify that the first mobile subscriber identifier is associated with a subscriber of the first MNO. At block 1130, the AP may determine an access credential that is available for distribution by the first MNO to the first mobile device via a messaging service of the first MNO. The access credential may be pre-shared between the AP and the first MNO or may be generated in response to receiving the first mobile subscriber identifier. Depending on the implementation, the access credential may be generated by either the AP or an authentication server of the first MNO. At block 1140, the AP may receive the access credential from the first mobile device. At block 1150, the AP may change the limit on the internet access via the first wireless connection in response to receiving the access credential from the first mobile device. For example, the AP may modify the first wireless connection to have unlimited access to the internet or may change the first wireless connection to have a limit imposed by a policy of the MNO.

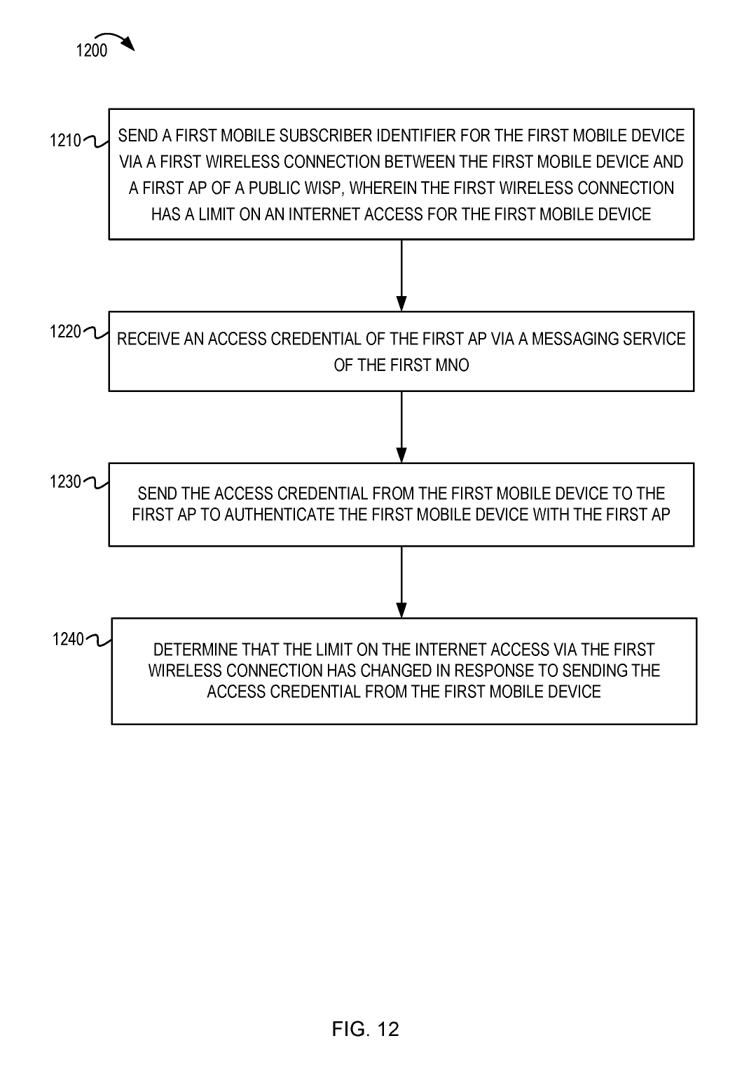

FIG. 12 depicts a flowchart for a mobile device. The flowchart 1200 begins at block 1210. At block 1210, the mobile device may send a first mobile subscriber identifier for the mobile device via a first wireless connection between the mobile device and a first AP of the public WISP. The first wireless connection may initially have a limit on an internet access for the mobile device. At block 1220, the mobile device may receive an access credential of the first AP via a messaging service of the first MNO. For example, the access credential may be contained in an SMS message from the first MNO to the mobile device. At block 1230, the mobile device may send the access credential from the mobile device to the first AP to authenticate the mobile device with the first AP. At block 1240, the mobile device may determine that the limit on the internet access via the first wireless connection has changed in response to sending the access credential from the mobile device. For example, the mobile device may be capable of accessing the internet after sending the access credential to the first AP.

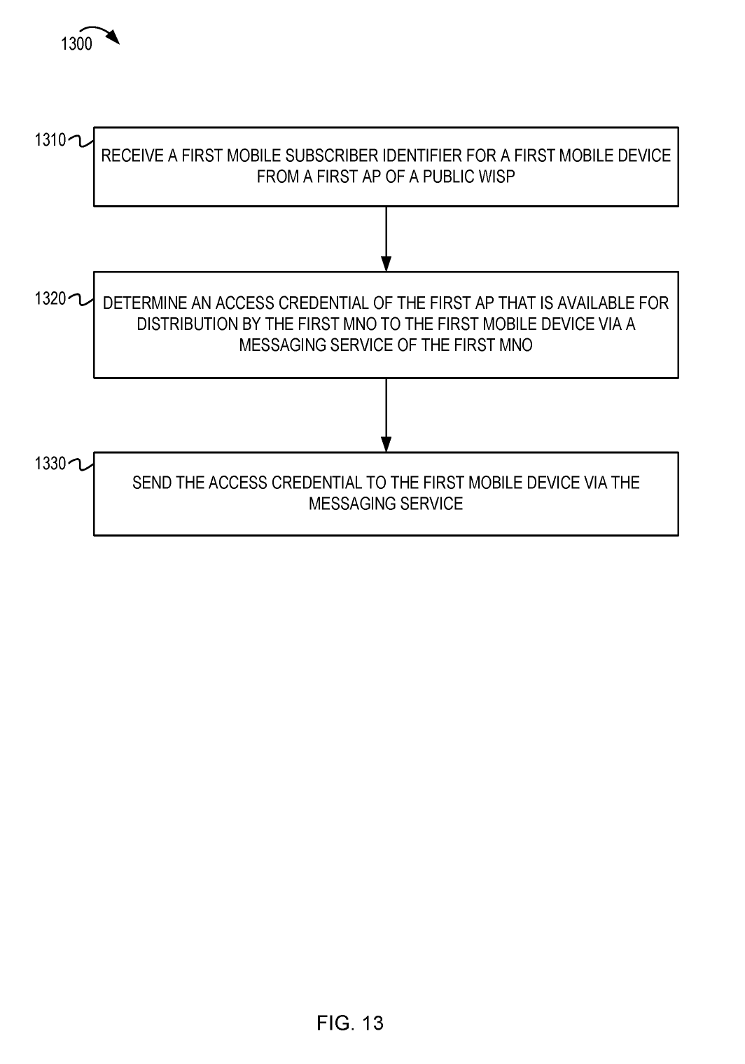

FIG. 13 depicts a flowchart for an authentication server of an MNO. The flowchart 1300 begins at block 1310. At block 1310, the authentication server may receive a first mobile subscriber identifier for a mobile device from a first AP of a public WISP. At block 1320, the authentication server may determine an access credential of the first AP that is available for distribution by the first MNO to the mobile device via a messaging service of the first MNO. At block 1330, the authentication server may send the access credential to the mobile device via the messaging service.

In some implementations, the flowchart 1300 may include additional blocks. For example, the authentication server may send policy configuration to the first AP based on user-specific or MNO-specific policies The authentication server may be configured to receive accounting information from the first AP. The first MNO may be configured to bill the subscriber for utilization of the public WISP on behalf of the public WISP.

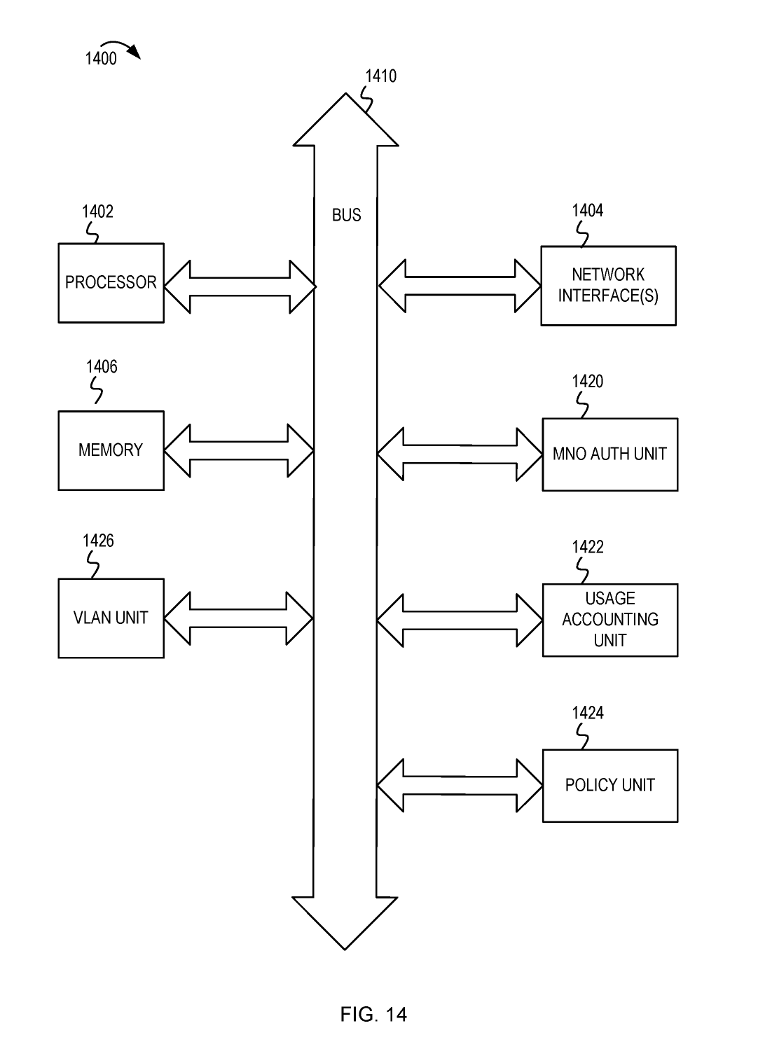

FIG. 14 shows a block diagram of an example electronic device for implementing aspects of this disclosure. In some implementations, the electronic device 1400 may be one of an access point (including any of the APs described herein). The electronic device 1400 can include a processor unit 1402 (possibly including multiple processors, multiple cores, multiple nodes, or implementing multi-threading, etc.). The electronic device 1400 also can include a memory unit 1406. The memory unit 1406 may be system memory or any one or more of the below-described possible realizations of computer-readable media. The electronic device 1400 also can include a bus 1410 (such as PCI, ISA, PCI-Express, HyperTransport®, InfiniBand®, NuBus, AHB, AXI, etc.), and a network interface 1404 that can include at least one of a wireless network interface (such as a WLAN interface, a Bluetooth® interface, a WiMAX interface, a ZigBee® interface, a Wireless USB interface, etc.) and a wired network interface (such as an Ethernet interface, a powerline communication interface, etc.). In some implementations, the electronic device 1400 may support multiple network interfaces—each of which is configured to couple the electronic device 1400 to a different communication network.

The electronic device 1400 may include an MNO authentication unit 1420 that can perform some or all of the operations described in FIGS. 1-13 above. For example, the MNO authentication unit 1420 may be similar to the MNO authentication unit 721 described in FIGS. 7 and 8. The MNO authentication unit 1420 also may implement the onboarding process described above, such as receiving MNO configurations or profile settings, or by executing an application to communicate with one or more MNOs. The MNO authentication unit 1420 also may coordinate with other components of the electronic device 1400 to implement usage accounting, policy enforcement, or traffic separation. For example, the electronic device 1400 may include a policy unit 1424 (similar to policy unit 726), a usage accounting unit 1426 (similar to usage accounting unit 724), or a VLAN unit 1428 (to implement VLANs similar to those described in FIG. 8).

The memory unit 1406 can include computer instructions executable by the processor unit 1402 to implement the functionality of the implementations described in FIGS. 1-13 above. Any one of these functionalities may be partially (or entirely) implemented in hardware or on the processor unit 1402. For example, the functionality may be implemented with an application specific integrated circuit, in logic implemented in the processor unit 1402, in a co-processor on a peripheral device or card, etc. Further, realizations may include fewer or additional components not illustrated in FIG. 14 (such as video cards, audio cards, additional network interfaces, peripheral devices, etc.). The processor unit 1402, the memory unit 1406, the network interface 1404, and the network configurator unit 1408 are coupled to the bus 1410. Although illustrated as being coupled to the bus 1410, the memory unit 1406 may be coupled to the processor unit 1402.

FIGS. 1-13 and the operations described herein are examples meant to aid in understanding example implementations and should not be used to limit the potential implementations or limit scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray′ disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method performed by a first access point (AP) of a public wireless internet service provider (WISP), the method comprising:
receiving a first mobile subscriber identifier for a first mobile device via a first wireless connection between the first mobile device and the first AP, wherein the first wireless connection has a limit on an internet access for the first mobile device;
sending the first mobile subscriber identifier to a first mobile network operator (MNO);
determining an access credential of the first AP that is available for distribution by the first MNO to the first mobile device via a messaging service of the first MNO;
receiving the access credential from the first mobile device; and
changing the limit on the internet access via the first wireless connection in response to receiving the access credential from the first mobile device.

2. The method of claim 1, further comprising:
creating an authentication relationship between the first AP of the public WISP and an authentication server of the first MNO before sending the first mobile subscriber identifier to the first MNO.

3. The method of claim 2, wherein creating the authentication relationship includes the first AP executing an application configured to communicate with the authentication server.

4. The method of claim 1, further comprising, before receiving the first mobile subscriber identifier for the first mobile device:
establishing the first wireless connection between the first mobile device and the first AP; and
sending a request for the first mobile subscriber identifier to the first mobile device.

5. The method of claim 1, further comprising:
communicating the access credential between the first AP of the public WISP and the first MNO such that the first MNO authorizes the first mobile device to utilize the first AP by providing the access credential to the first mobile device.

6. The method of claim 1, wherein the access credential can be used for authentication with both the first AP and a second AP of the public WISP.

7. The method of claim 1, wherein the messaging service is a short messaging service (SMS).

8. The method of claim 1, wherein determining the access credential includes:
receiving the access credential from an authentication server of the first MNO, wherein the access credential is specific to a subscriber of the first MNO that is associated with the first mobile subscriber identifier.

9. The method of claim 1, further comprising:
sending a temporary access credential to the first MNO with the first mobile subscriber identifier,
wherein determining the access credential includes generating the temporary access credential in response to receiving the first mobile subscriber identifier.

10. The method of claim 1, further comprising:
receiving a policy configuration from the first MNO; and
implementing the policy configuration at the first AP.

11. The method of claim 10, wherein the policy configuration includes at least one user-specific setting for a subscriber of the first MNO that is associated with the first mobile subscriber identifier.

12. The method of claim 10, wherein the policy configuration includes at least one parameter set by the first MNO for all subscribers of the first MNO.

13. The method of claim 10, wherein changing the limit on the internet access includes increasing the limit based, at least in part, on the policy configuration from the first MNO.

14. The method of claim 1, further comprising:
implementing a first virtual local area network (VLAN) at the first AP to separate data traffic for the first mobile device from a second VLAN for another device.

15. The method of claim 1, further comprising:
measuring a usage of the internet access; and
providing accounting information to the first MNO, wherein the accounting information is based, at least in part, on the usage.

16. The method of claim 15, wherein providing the accounting information includes sending the accounting information to an accounting server of the first MNO.

17. The method of claim 1, further comprising:
receiving a second mobile subscriber identifier for a second mobile device via a second wireless connection between the second mobile device and the first AP, wherein the second wireless connection has a limit on an internet access for the second mobile device;
sending the second mobile subscriber identifier to a second MNO that is different from the first MNO;
determining a second access credential of the first AP that is available for distribution by the second MNO to the first mobile device via a messaging service of the second MNO;
receiving the second access credential from the second mobile device; and
changing the limit on the internet access via the second wireless connection in response to receiving the second access credential from the second mobile device.

18. The method of claim 1, further comprising:
establishing a second wireless connection between a second mobile device and the first AP, wherein the second wireless connection has a limit on an internet access for the second mobile device;
receiving the access credential from the second mobile device, wherein the access credential received from the first mobile device and the second mobile device is the same; and
changing the limit on the internet access via the second wireless connection in response to receiving the access credential from the second mobile device.

19. The method of claim 1, wherein the first AP is a mobile AP.

20. The method of claim 19, wherein the mobile AP is deployed in a vehicle.

21. The method of claim 1,
wherein the first AP is a mobile hotspot associated with a second mobile device having a mobile internet service from a second MNO that is different from the first MNO, and
wherein the internet access for the first mobile device and the second mobile device is provided by the mobile internet service from the second MNO.

22. A first AP of a public WISP, comprising:
a processor; and
memory for storing instructions, which when executed by the processor, cause the first AP to:
receive a first mobile subscriber identifier for a first mobile device via a first wireless connection between the first mobile device and the first AP, wherein the first wireless connection has a limit on an internet access for the first mobile device;
send the first mobile subscriber identifier to a first MNO;
determine an access credential of the first AP that is available for distribution by the first MNO to the first mobile device via a messaging service of the first MNO;
receive, by the first AP, the access credential from the first mobile device; and
change the limit on the internet access via the first wireless connection in response to receiving the access credential from the first mobile device.

23. The first AP of claim 22, wherein the instructions to determine the access credential includes instructions which, when executed by the processor, cause the first AP to:
receive the access credential from an authentication server of the first MNO, wherein the access credential is specific to a subscriber of the first MNO that is associated with the first mobile subscriber identifier.

24. The first AP of claim 22, wherein the instructions, when executed by the processor, further cause the first AP to:
send a temporary access credential to the first MNO with the first mobile subscriber identifier,
wherein the instructions to determine the access credential includes instructions, when executed by the processor, further cause the first AP to generate the temporary access credential in response to receiving the first mobile subscriber identifier.

25. The first AP of claim 22, wherein the instructions, when executed by the processor, further cause the first AP to:
measure a usage of the internet access; and
provide accounting information to the first MNO, wherein the accounting information is based, at least in part, on the usage.

26. A system comprising:
means for receiving a first mobile subscriber identifier for a first mobile device via a first wireless connection between the first mobile device and a first AP of a public WISP, wherein the first wireless connection has a limit on an internet access for the first mobile device;
means for sending the first mobile subscriber identifier to a first MNO;
means for determining an access credential of the first AP that is available for distribution by the first MNO to the first mobile device via a messaging service of the first MNO;
means for receiving the access credential from the first mobile device; and
means for changing the limit on the internet access via the first wireless connection in response to receiving the access credential from the first mobile device.

27. The system of claim 26, wherein the messaging service is a short messaging service (SMS).

28. A method performed by a first mobile device, comprising:
sending a first mobile subscriber identifier for the first mobile device via a first wireless connection between the first mobile device and a first AP of a public WISP, wherein the first wireless connection has a limit on an internet access for the first mobile device;
receiving an access credential of the first AP via a messaging service of a first MNO;
sending the access credential from the first mobile device to the first AP to authenticate the first mobile device with the first AP; and
determining that the limit on the internet access via the first wireless connection has changed in response to sending the access credential from the first mobile device.

29. The method of claim 28,
wherein receiving the access credential includes receiving the access credential by a connection manager of the first mobile device, and
wherein sending the access credential includes automatically sending, by the connection manager, the access credential to the first AP.

30. The method of claim 28, wherein receiving the access credential includes displaying the access credential on a display of the first mobile device.
